(19) United States
(12) Patent Application Publication
(10) Pub. No.: US 2011/0218931 A1
(43) Pub. Date: Sep. 8, 2011

(54) Notifications in a Social Network Service

(75) Inventors: Angus Phillip Donald Logan, Seattle, WA (US); Jeffrey C. Kunins, Seattle, WA (US); Douglas R. Pearce, Seattle, WA (US)

(73) Assignee: Microsoft Corporation, Redmond, WA (US)

(21) Appl. No.: 12/716,996

(22) Filed: Mar. 3, 2010

(51) Int. Cl. G06F 15/16; G06F 17/30; G06Q 99/00; G06F 15/18

(52) U.S. Cl. 705/319; 709/206; 707/758; 707/E17.014; 706/12

(57) ABSTRACT

Notification techniques in a social network service are described. In an implementation, a status update is analyzed that is communicated via a social network service and is originated by a user. One or more other status updates are located that correspond to the analyzed status update, the one or more other status updates are communicated via the social network service and originated by one or more other users. A notification is formed to be communicated to the originating user that indicates the one or more other status updates have been located.

Social network services continue to increase in popularity. For example, users may leverage a social network service to find and interact with other users, such as friends, business contacts, and so on. This interaction may be performed in a variety of ways, such as through messaging, photo sharing, posting videos, and so on. Additionally, this interaction may take a variety of different forms.

For example, users may interact regarding a variety of different topics such as from talking about their families to their respective experience with products or services. In this way, users may share their thoughts regarding a variety of different topics with other users of the social network service. However, traditional techniques that were employed by social network services to permit this sharing were limited. Although other users may comment on what was being shared for a particular topic, for instance, these comments were limited to being applied in response to the initiating comment. Thus, other users that may be interested in the topic being discussed could miss the topic altogether if not involved in that particular string of comments.

### SUMMARY

Notification techniques in a social network service are described. In an implementation, a status update is analyzed that is communicated via a social network service and is originated by a user. One or more other status updates are located that correspond to the analyzed status update, the one or more other status updates are communicated via the social network service and originated by one or more other users. A notification is formed to be communicated to the originating user that indicates the one or more other status updates have been located.

In an implementation, a plurality of content of one or more friends of a user in a social network service is searched, automatically and without user intervention, to locate at least one item of content that corresponds to user-generated content to be communicated from the user to the one or more friends of the user. Responsive to the location of the at least one item of content, the user is notified that the at least one item of content is located.

In an implementation, one or more tangible computer-readable media comprise instructions stored thereon that, responsive to execution on a computing device, causes the computing device to extract one or more keywords from a status update that is communicated via a social network service and is originated by a user. User-generated content is located that corresponds to the extracted one or more keywords, the user-generated content is communicated via the social network service and originated by one or more other users that are permitted to access the status update that is originated by the user. A communication is formed to be communicated to the originating user that includes the located one or more other status updates.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform social network service notification techniques.

FIG. 2 is an illustration of an example system that depicts formation of notifications responsive to communication of content via the social network service of FIG. 1.

FIG. 3 is an illustration showing an example implementation in which a user interface is output by a client device of FIG. 1 that includes notifications with a social network service.

FIG. 4 is a flow diagram depicting a procedure in an example implementation in which a status update is analyzed and used as a basis to form a notification to be communicated to the originating user regarding related content.

FIG. 5 is a flow diagram depicting a procedure in an example implementation in which user-generated content of friends of a user is searched to locate user-generated content that corresponds to the user-generated content of the user.

### DETAILED DESCRIPTION

Overview

Users of a social network service may share a variety of different content to interact in a variety of different ways. However, traditional techniques that were employed to share content were often one sided and/or limited in the amount of feedback that was provided to a person that shared the content. Therefore, the users may develop new interests and thus spend less time interacting via the social network service. This may be detrimental to users of the social network service as well as to the social network service itself.

Social network notification techniques are described. In an implementation, users of a social network service that share content with other users are provided with a notification of content that is related to the content that was shared by the user. For example, a user may share thoughts on a restaurant via a status message that is communicated via the social network service. In response, the user may be notified as to the existence of other status messages that also pertain to the restaurant. In this way, the user is provided with an incentive to share content via the social network service (e.g., feedback from others), which may encourage the user to remain active in relation to the service. Further discussion of notification techniques may be found in relation to the following sections.

In the following discussion, an example environment is first described that is operable to perform social network notification techniques. Example procedures are then described which may be employed by the example environment. However, it should be readily apparent that the example environment is not limited to performing the example techniques and the example techniques are not limited to performance in the example environment.

Example Environment

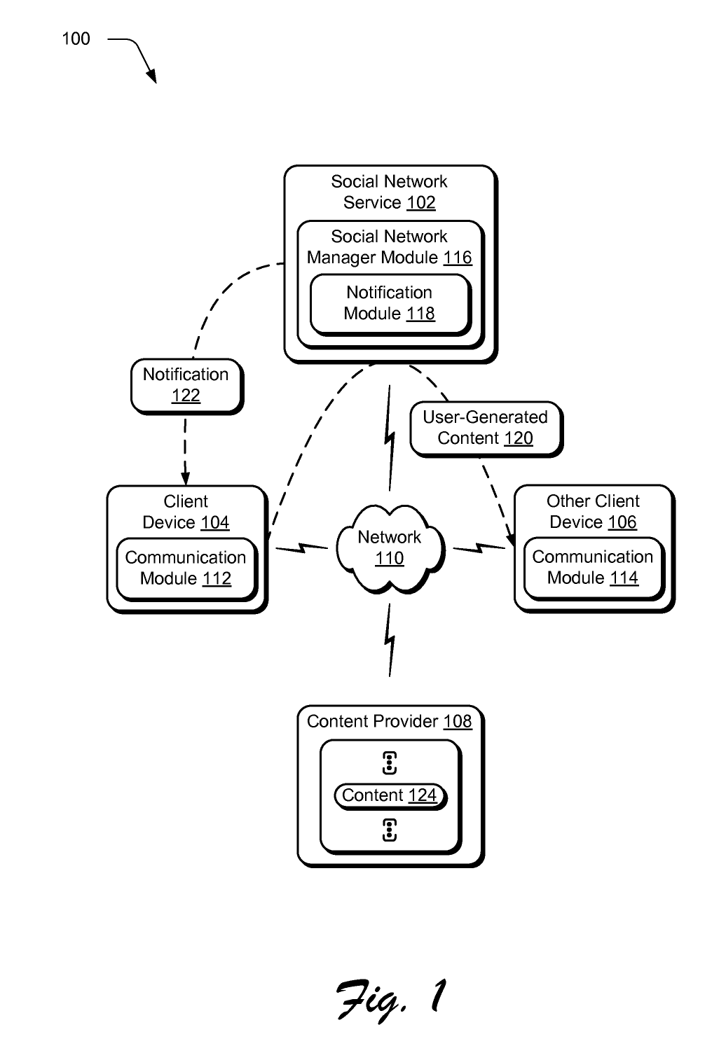

FIG. 1 is an illustration of an environment 100 in an example implementation that is operable to employ notification techniques in a social network service. The illustrated environment 100 includes a social network service 102, a client device 104, another client device 106, and a content provider 108, each of which are communicatively coupled, one to another, over a network 110.

The client devices 104, 106 may be configured in a variety of ways. For example, the client devices 104, 106 may be configured as a computing device that is capable of communicating over the network 110, such as a desktop computer, a mobile station, an entertainment appliance, a set-top box communicatively coupled to a display device, a wireless phone, a game console, and so forth. Thus, the client devices 104, 106 may range from full resource devices with substantial memory and processor resources (e.g., personal computers, game consoles) to a low-resource device with limited memory and/or processing resources (e.g., traditional set-top boxes, hand-held game consoles). The client devices 104, 106 may also relate to an entity that operates the client devices 104, 106. In other words, client devices 104, 106 may describe logical clients that include software in the following discussion.

Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks. For instance, the social network service 102 and the client devices 104, 106 may be communicatively coupled via the Internet. Additionally, both the client devices 104, 106 may be communicatively coupled via a local wireless network. A wide variety of other instances are also contemplated.

The client devices 104, 106 are each illustrated as including a respective communication module 112, 114. The communication modules 112, 114 are representative of functionality of the respective client devices 104, 106 to communicate via the network 110. For example, the communication modules 112, 114 may include browser functionality to interact with the social network service 102 via the network 110.

The social network service 102 may support a variety of different functionality which is represented by the social network manager module 116. Through the social network manager module 116, for instance, the social network service 102 may support communication of status updates between the client devices 104, 106 that have been specified as friends of each other. Additionally, the specified “friendship” of the social network service 102 may be used as a basis to permit sharing of photos, video, blogs, and so on. Thus, the social network service 102 may use the friend relationship as a technique to permit or restrict access to content associated with a user's account of the social network service 102.

For instance, the client device 102 may be associated with a user's account of the social network service 102. Through this user account, the client device 104 may be used to specify a friend, such as a user account of the social network service 102 that is accessible via the other client device 106. By doing this, the other client device 106 is permitted to access content associated with the client device 104, such as content associated with an account of the social network service 102 of a user of the client device 104 that provided credentials to access the user account. Although a permission system involving friends has been described, it should be readily apparent that the social network service 102 may be configured in a variety of ways to support communication between users. For example, the social network manager module 116 may support blogging and micro-blogging (e.g., having a limited number of characters such as 140) to communicate status updates to subscribers of a particular user, e.g., via the social network service 102 (e.g., an email), via a SMS, and so on.

The social network service 102, and more particularly the social network manager module 116, is also illustrated as including a notification module 118 that is representative of functionality regarding notifications. For instance, the notification module 118 may be representative of functionality regarding identification of content, locating related content, and notification of the location of the related content to users of the social network service 102.

In the illustrated example, a user of client device 104 originates user-generated content 112, which is communicated to a user of the other client device 106 via the social network service 102. The user-generated content 122 may take a variety of forms, such as a message (e.g., email), posting, status update, and so on. Responsive to this communication (or attempt to do so) of the user-generated content 120, the notification module 118 forms a notification 122 to be communicated to a user of the client device 104. This notification 122 may be configured in a variety of ways.

For instance, the notification 122 may be configured to inform a user of the client device 104 of other content that relates to the user-generated content 120. This other content may also be configured in a variety of ways, such as user-generated content that was originated by another user of the other client device 106 (e.g., via the communication module 114) or other users of the social network service, may reference content 124 of the content provider 108, and so on. Thus, in this example environment 100 the notification 122 may provide a technique to encourage users to “share” with each other via the social network service 102. A variety of different techniques may be used to locate related content and configure the notification 122, further discussion of which may be found in relation to the following figure.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, the module or functionality represents program code that performs specified tasks when executed on a processor (e.g., CPU or CPUs). The program code can be stored in one or more computer readable memory devices, e.g., memory or other tangible media. The features of the notification techniques described below are platform-independent, meaning that the techniques may be implemented on a variety of commercial computing platforms having a variety of processors.

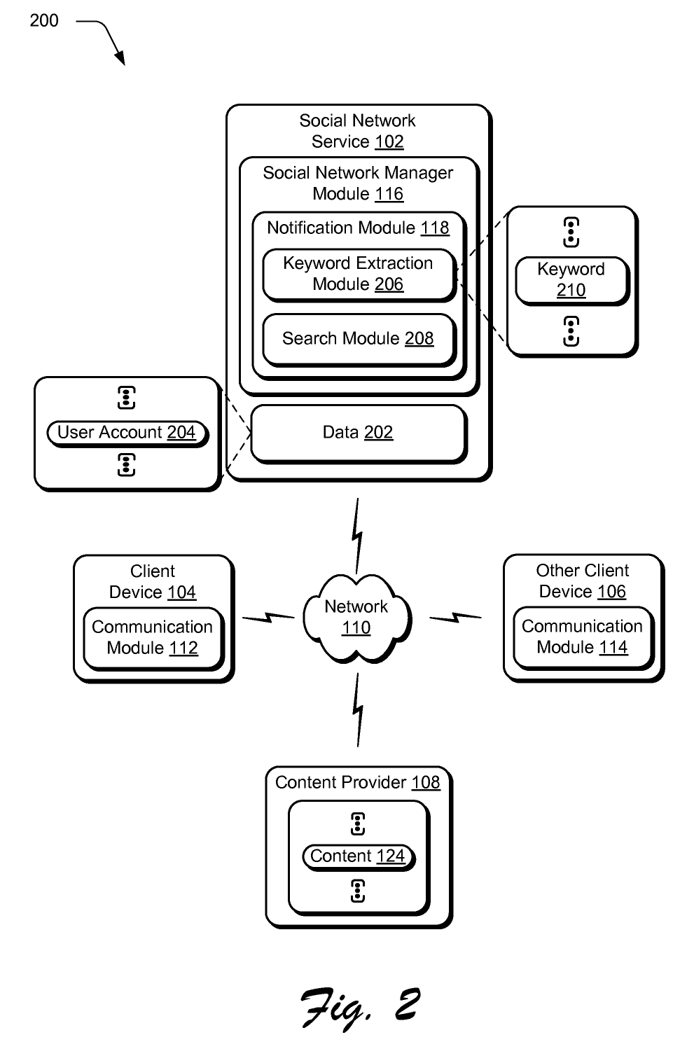

FIG. 2 depicts an example system 200 illustrating formation of a notification in an example implementation. In the illustrated implementation, the social network service 102 includes data 202 that describes content that is communicated via the social network service 102, such as through one or more user accounts 204. For example, the data 202 may describe user-generated content, such as status updates, postings, and other user-generated media that is to be communicated via the social network service 102. The data 202 may also described other content, such as the content 124 that is available via the network 110 from the content provider 108 via the network 110 or elsewhere.

The notification module 118 in this example is illustrated as including a keyword extraction module 206 and a search module 208. The keyword extraction module 206 is representative of functionality of the social network service 102 to identify one or more keywords 210 in the data 202. For example, the keywords may include personal names, business names, addresses, GPS location data, media titles, and so on. The keywords identified by the keyword extraction module 206 may then be leveraged by the search module 208 to locate content that corresponds to those keywords, an example of which is described in relation to the following figure.

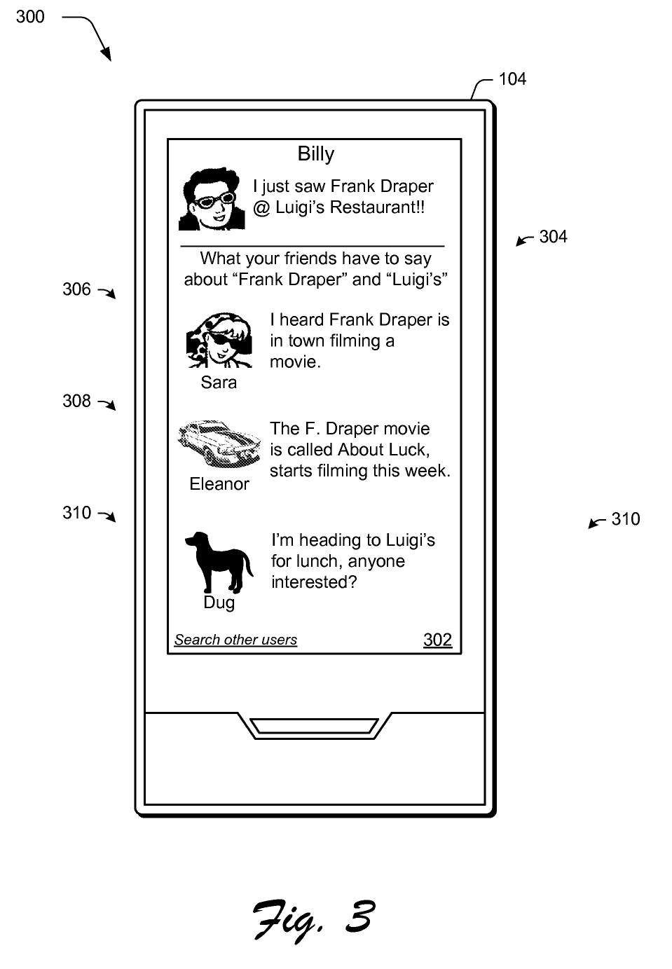

FIG. 3 is an illustration showing an example implementation 300 in which a user interface 302 is output by the client device 104 of FIG. 1 to interact with the social network service 102. This user interface 302 is configured to display a network feed of status updates for friends of a user “Billy” in the social network service 102. In the illustration, “Billy” has input a status update that indicates that “I just saw Frank Draper @ Luigi's Restaurant,” which is to be communicated to friends of Billy in the social network service 102.

Responsive to the communication of the status update, the notification module 118 may leverage functionality of the keyword extraction module 206 to extract keywords 210 from the status update. In this example, the keywords 210 are “Frank Draper” and “Luigi's.” These keywords may then be provided to the search module 208 to locate other content that corresponds to these keywords, examples of which are illustrated in the user interface 302.

For example, the user interface includes a section 304 that may be provided in response to transmittal of the status update by Billy that includes other status updates communicated by friends of Billy. This section includes the text “What your friends have to say about ‘Frank Draper’ and ‘Luigi's.’” For example, first and second status updates 306, 308 relate to the keywords “Frank Draper” while the third status update 310 relates to “Luigi's.” In this way, the user Billy is notified automatically and without further user intervention as to the existence of related content from friends of Billy. Although friends have been described, it should be readily apparent that a variety of different social network service types are also contemplated (e.g., micro-blogging) as well as a variety of different techniques to form the notifications, further discussion of which may be found in relation to the following procedures.

Example Procedures

The following discussion describes notification techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, and the client device 104 of FIG. 3.

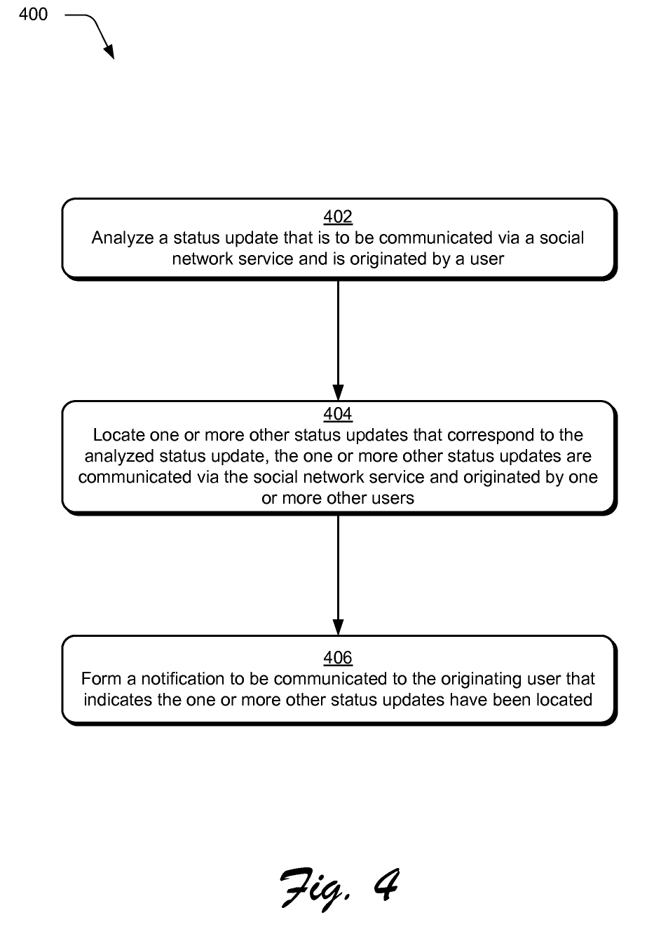

FIG. 4 depicts a procedure 400 in an example implementation in which a status update is analyzed and used as a basis to form a notification to be communicated to the originating user regarding related content. A status update is analyzed that is to be communicated via a social network service and is originated by a user (block 402). For example, a user of client device 104 (through interaction with the communication module 112) may input a status update to be communicated to another user of the social network service 102, e.g., a user of the other client device 106. The user of the other client device 106 has been designated as a friend of the user of the client device 104 as previously described.

Responsive to the attempt to communicate the status update, the notification module 118 analyzes the status update. A variety of different analysis may be performed, such as keyword extraction, use of one or more machine learning algorithms (e.g., a support vector machine (SVM) or latent semantic indexing (LSI)), and so on.

One or more other status updates are located that correspond to the analyzed status update, the one or more other status updates are communicated via the social network service and originated by one or more other users (block 404). Continuing with the previous example, keywords or other data that was formed from the analysis above that describes the status update may be used to locate similar status updates, such as status updates having a similar topic, similar (and not necessarily matching) keywords, pertain to a similar location (e.g., through GPS coordinates), and so on.

A notification is formed to be communicated to the originating user that indicates that one or more other status updates have been located (block 406). For example, the notification may reference that the other status updates have been located and give the user an option to view them. The notification may also include a summary of the other status updates or even contain the status updates themselves, e.g., the user interface 302 of FIG. 3. The notification, for instance, may be configured as a SMS while the status updates are communicated via email. In another instance, the located status updates may be appended like comments to the status update for display in a network feed.

Further, the status updates may be prioritized. For instance, the status updates may be ranked in an order of relevance with an “X” number of relevant status updates being communicated to the originating user. Relevance may be computed in a variety of ways for purposes of prioritizing, such as based on time, keyword matching, and so on. A variety of other examples are also contemplated involving different types of content, an example of which is described in relation to the following figure.

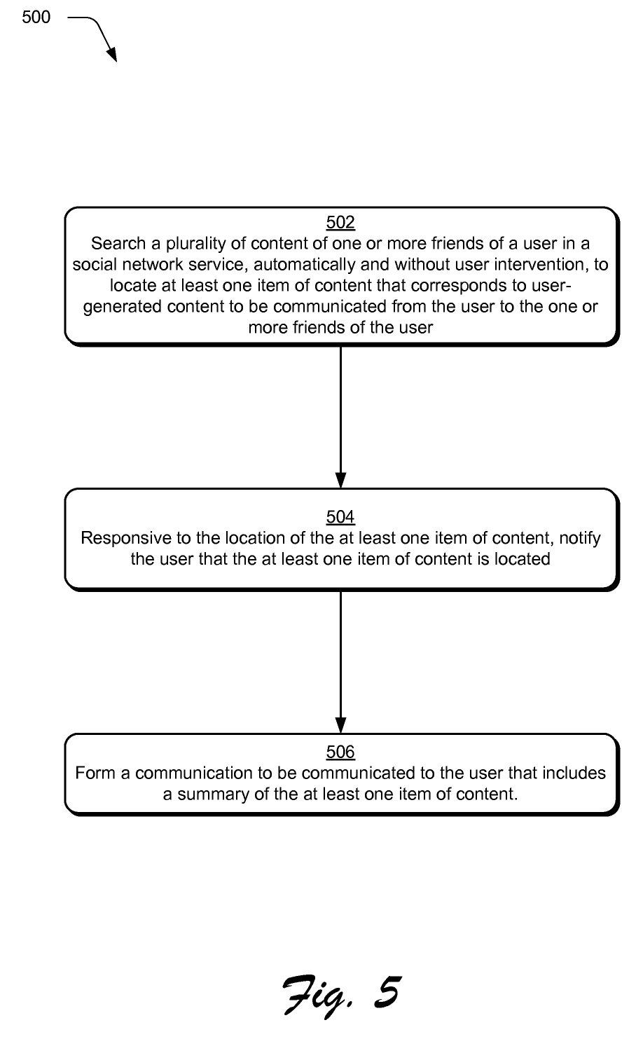

FIG. 5 depicts a procedure 500 in an example implementation in which user-generated content of friends of a user is searched to locate content that corresponds to the user-generated content of the user. A plurality of content of one or more friends of a user in a social network service is searched, automatically and without user intervention, to locate at least one item of content that corresponds to user-generated content to be communicated from the user to the one or more friends of the user (block 502). For example, the search may be performed for a variety of different content, such as postings, status updates, email, SMS, MMS, or other user-generated media.

Responsive to the location of the at least one item of content, the user is notified that the at least one item of content is located (block 504). As before, this notification may be performed in a variety of ways, such as in a user's network feed of status updates (e.g., as a status update), via SMS, email, and so on. Additionally, the notification may be configured in a variety of ways, such as to indicate the existence of the related user-generated content without actually containing the content. A variety of other examples are also contemplated as previously described.

A communication is formed to be communicated to the user that includes a summary of at least one item of content (block 506). For example, the communication may describe the type of content and what is contained in the content, e.g., a status update from “X,” a video link and title, and so forth. As previously described, in an implementation, the notification and the communication may be communicated together, e.g., the notification contains a summary of the content.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by at least one computing device, the method comprising:
analyzing a status update that is to be communicated via a social network service and is originated by a user;
locating one or more other status updates that correspond to the analyzed status update, the one or more other status updates are communicated via the social network service and originated by one or more other users; and
forming a notification to be communicated to the originating user that indicates the one or more other status updates have been located.

2. A method of claim 1, wherein the analyzing includes a keyword search and the locating leverages a result of the keyword search.

3. A method of claim 1, wherein the status update includes an indication of a location of the originating user and the locating is performed at least in part by leveraging the indication.

4. A method of claim 1, wherein the one or more other users have subscribed to receive the status update that is originated by the user.

5. A method of claim 1, wherein the one or more other users are specified as friends of the user and are thereby have permission to access the status update that is originated by the user.

6. A method of claim 5, wherein the status update is not accessible to the one or more other users absent the permission provided by the specification as friends.

7. A method of claim 5, wherein the locating is not performed for at least one user of the social network service that is not specified as a friend of the originating user.

8. A method of claim 1, wherein the notification is to be communicated via the social network service to the originating user and includes a summary of the one or more other status updates.

9. A method of claim 8, wherein the notification is to be displayed in a user interface as part of a network feed.

10. A method of claim 1, wherein the communication is configured in accordance with a SMS.

11. A method of claim 1, further comprising prioritizing the one or more other status updates and wherein the communication includes the one or more other status updates as prioritized.

12. A method implemented by at least one computing device, the method comprising:
searching a plurality of content of one or more friends of a user in a social network service, automatically and without user intervention, to locate at least one item of said content that corresponds to user-generated content to be communicated from the user to the one or more friends of the user; and
responsive to the location of the at least one item of said content, notifying the user that the at least one item of said d content is located.

13. A method of claim 12, wherein the content is user-generated content that includes a status update, an email message communicated via the social network service, a blog post, or a micro-blog post having less that a predetermined number of characters.

14. A method of claim 12, wherein the searching includes extracting one or more keywords from the user-generated content to be communicated from the user to the one or more friends of the user and finding the at least one item of said content that corresponds to the extracted one or more keywords.

15. A method of claim 12, further comprising forming a communication to be communicated to the user that includes a summary of the at least one item of said content.

16. A method of claim 12, wherein the notifying is configured to be performed using SMS and the communication is configured to be performed using email.

17. A method of claim 12, wherein the searching is performed using one or more machine learning algorithms.

18. A method of claim 17, wherein the one or more machine learning algorithms include a support vector machine (SVM) or latent semantic indexing (LSI).

19. One or more tangible computer-readable media comprising instructions stored thereon that, responsive to execution on a computing device, causes the computing device to:
extract one or more keywords from a status update that is communicated via a social network service and is originated by a user;
locate user-generated content that correspond to the extracted one or more keywords, the user-generated content is communicated via the social network service and originated by one or more other users that are permitted to access the status update that is originated by the user; and
form a communication to be communicated to the originating user that includes the located one or more other status updates.

20. One or more tangible computer-readable media of claim 19, wherein the user-generated content is another status update.
